(19) United States
(12) Patent Application Publication
(10) Pub. No.: US 2002/0081539 A1
(43) Pub. Date: Jun. 27, 2002

(54) Supporting material, silver halide photographic photosensitive material and photosensitive transfer material

(75) Inventors: Yoshimitsu Ito, Shizuoka-ken (JP); Yutaka Matsumoto, Shizuoka-ken (JP); Tatsuya Nomura, Shizuoka-ken (JP)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: FUJI PHOTO FILM CO., LTD.

(21) Appl. No.: 09/985,864

(22) Filed: Nov. 6, 2001

(30) Foreign Application Priority Data
Nov. 8, 2000 (JP) 2000-340237

(51) Int. Cl. G03C 1/85; G03C 1/76

(52) U.S. Cl. 430/523; 430/527

(57) ABSTRACT

A supporting material is provided which has excellent antistatic ability and has a high film membrane strength, and in which peeling-off of a layer in a manufacturing process or at the time of handling (coating or conveying) is prevented and white-powder contamination and adhesion of foreign matters caused by falling of an antistatic agent and also failure of liquid film repellency caused by the white-powder contamination and adhesion of foreign matters are prevented. This supporting material also has excellent transparency and high scratch resistance. The supporting material has, on one surface of a substrate, an antistatic layer and a protective layer formed in the order given. The antistatic layer comprises acicular metal oxide grains, and the protective layer comprises an epoxy cross-linking agent and a sulfuric ester based surface active agent represented by CₙH₂ₙ₊₁OSO₃Na, wherein n represents an integer of 12 to 18.

### BACKGROUND OF THE INVENTION

1. Field of the Invention

The present invention relates to a supporting material having an antistatic layer and a protective layer, and also to a silver halide photographic photosensitive material and a photosensitive transfer material each having the supporting material. Specifically, it relates to a supporting material having an antistatic layer and a protective layer, in which excellent transparency and a high antistatic effect are obtained and peeling-off is not apt to occur, and also relates to a silver halide photographic photosensitive material and a photosensitive transfer material which are each comprised of the supporting material.

2. Description of the Related Art

A silver halide photographic photosensitive material is generally manufactured by forming, on a substrate such as an electrical insulating plastic film, a photosensitive silver halide photographic emulsion layer (i.e., a silver halide photographic photosensitive layer), an antihalation layer, a protective layer, an intermediate layer, an undercoat layer, an antistatic layer and the like.

In recent years, the manufacturing technique of silver halide photographic photosensitive materials has been remarkably improved. The coating rate of an undercoat layer or a silver halide photographic photosensitive layer, for example, has been increased, and shredding and cutting processings have been carried out at higher speeds. Therefore, in each of manufacturing processes, scratching or peeling of a coating layer are apt to occur due to friction caused when a silver halide photographic photosensitive material contacts a conveying roll or the like. Further, due to the above-described higher-speed processing, the degree of contact friction increases, or the speed at which the photosensitive material is separated from the conveying roll, becomes higher. As a result, an amount of static electricity with which the silver halide photographic photosensitive material is charged tends to increase, and foreign matters or dust is more likely to adhere to the photosensitive material than before. Such scratches, layer peeling, or adhesion of foreign matters or dust causes formation of various spots which causes water repelling, desensitization, fogging and the like. Further, when static electricity accumulated by the contact friction is discharged, a so-called static mark is generated in the silver halide photographic photosensitive layer, which results in a serious defect.

The above-described tendency toward higher-speed processing is also seen in a photographing process (a latent-image forming process) using a camera or the like and in a development process using an automatic processor or the like. Therefore, scratches, layer peeling, generation of static electricity, and adhesion of foreign matters or dust are likely to occur due to contact friction.

Further, when image information recorded on the silver halide photographic photosensitive material is used in a further enlarged state as in a microfilm, a cinema film or the like, the quality of an image deteriorates due to foreign matters or dust caused to adhere to the film by static electricity, and the commercial value of the silver halide photographic photosensitive material as a recording material may be remarkably decreased.

A silver halide photographic photosensitive material having, as antistatic means, an antistatic layer containing electro-conductive polymer, ionic or nonionic surface active agent, colloidal silica, metal oxide or composite oxide thereof, or the like is known as a material in which the generation of static electricity is prevented. However, there are cases in which a substance dissolved in a developing solution during development processing, for example a surface active agent, may not only lose its antistatic property after development processing, but it may also deteriorate the developing solution and the like, thereby resulting in deterioration of photographic characteristics. Further, in a low-humidity environment such as in the winter season, sufficient antistatic property is generally not obtained by an antistatic agent such as electro-conductive polymer because the polymer has ionic electric conductivity.

In view of the foregoing, as the antistatic agent, metal oxides, composite oxides thereof, or fine grains having a small amount of heteroatoms contained in the oxides are preferable from the standpoint of preventing deterioration in photographic characteristics during development processing and loss of the antistatic ability as a result of the development processing. For example, Japanese Patent Application Publication (JP-B) No. 1-20736 and Japanese Patent Application Laid-Open (JP-A) Nos. 61-20033 and 4-39651 each disclose an antistatic layer containing the above-described antistatic agent.

However, in a case in which the above-described metal oxide or the like is used, there is a problem that so-called white-powder contamination is likely to occur. When this occurs, the oxide falls off from the surface of the layer due to the contact friction with a conveying roll and the like during the manufacturing process and adheres to the surface of the conveying roll. That is, grains falling off from the layer and adhering to the conveying roll or the like, later adhere once again to a substrate in the manufacturing process, thereby resulting in poor coating, foreign matter defect, or occurrence of abrasion. Therefore, productivity is remarkably deteriorated.

In the process for forming an antistatic layer which contains the above-described metal oxide or the like, the layer thickness of the antistatic layer is smaller than a grain size of metal oxide grains, and therefore, most of the metal oxide is in a state in which it protrudes from the surface of the antistatic layer. The protruding portion of the metal oxide remains uncovered even when a protective layer is formed on the antistatic layer. Therefore, if the substrate is pressurized by a conveying roll in the process for forming a silver halide photographic photosensitive layer or the like, when the strength of the antistatic layer is not sufficient, the metal oxide or the like may fall from the layer.

In development processing using an automatic processor as well, a pressure-type conveying roll is employed for conveying silver halide photographic photosensitive material. Accordingly, there are also drawbacks in that even in the development processing, grains of metal oxide or the like fall from the layer, the developing solution deteriorates, the number of times which the automatic processor is cleaned increases, and the like.

In order to avoid the phenomenon in which the metal oxide or the like falls off, Japanese Patent Application Laid-Open (JP-A) No. 8-36239 discloses provision of an antistatic layer comprised of metal oxide grains, and hardened material of a melamine compound and at least one kind of polymer selected from a group consisting of acrylic resin, vinyl resin, polyurethane resin and polyester resin. According to the disclosure described therein, white-powder contamination caused by falling of metal oxide is reliably improved. However, electric conductivity of the antistatic layer is not sufficient in a microfilm or a cinema film, for which conveying conditions are particularly severe, and adhesion of foreign matters cannot be completely prevented. In order to get closer to solving this problem, if the amount of metal oxide is increased, a slight reduction in surface electrical resistance can be achieved. However, the amount of grains which fall from the layer increase, and therefore, white-powder contamination or adhesion of foreign matters is not alleviated. Moreover, a haze value is raised due to the increase in number of grains.

In the photographing process (latent-image forming process) using a camera or the like, when silver halide photographic photosensitive material is processed at high speed, the material may have defects on the surface thereof when, for example, it is removed from the camera, or image portions may be erased by being scratched off by the defects. Particularly, it is easy for the material in the charged state to come in contact with the apparatus, and defects or the like are likely to be caused thereon.

Further, the above-described charging caused by the contact friction, peeling-off of a layer, white-powder contamination, adhesion of foreign matters, and generation of abrasion also occur even in a photosensitive transfer material for forming a color filter by, for example, transferring a colored photosensitive resin layer thereto.

### SUMMARY OF THE INVENTION

In the existing circumstances, a supporting material has not yet been provided which has excellent electric conductivity, antistatic ability and transparency and in which peeling-off of a layer in a manufacturing process or at the time of handling (coating or conveying), adhesion of foreign matters to a substrate due to falling of an antistatic agent, and white-powder contamination is prevented, and whose supporting material also has excellent lubricating property and high scratch resistance.

The present invention has been devised to solve the above-described conventional various problems in a manufacturing process and achieve the following objects.

An object of the present invention is to provide a supporting material which has excellent electric conductivity and antistatic ability and has a high film membrane strength, and in which peeling-off of a layer in a manufacturing process or at the time of handling (coating or conveying), white-powder contamination and adhesion of foreign matters caused by falling of an antistatic agent and also failure due to liquid film repellency caused by the white-powder contamination and adhesion of foreign matters is prevented, and the supporting material also has excellent transparency and scratch resistance.

Another object of the present invention is to provide silver halide photographic photosensitive material and photosensitive transfer material, which each have excellent electric conductivity and antistatic ability and in which deterioration of the antistatic ability caused by peeling of a film at the time of handling (conveying or development), falling-off of an antistatic agent, or degradation of a developing solution is prevented, and which can reduce maintenance burden of an automatic processor, and which also has excellent transparency and scratch resistance, thereby making it possible to form a high-quality image which is free from any image defect.

A first aspect of the present invention is a supporting material having an antistatic layer formed on one surface of a substrate and a protective layer formed on the antistatic layer, wherein the antistatic layer comprises acicular metal oxide grains.

A second aspect of the present invention is a supporting material having an antistatic layer formed on one surface of a substrate and a protective layer formed on the antistatic layer, wherein the protective layer comprises an epoxy cross-linking agent, and a sulfuric ester based surface active agent represented by

CₙH₂ₙ₊₁OSO₃Na,

wherein N represents an integer of 12 to 18.

A third aspect of the present invention is a supporting material, wherein the epoxy cross-linking agent is an epoxy cross-linking agent in which the average number of epoxy functional groups in a molecule is 4.5 to 6.5.

A fourth aspect of the present invention is a supporting material, wherein the ratio of a major axis of the metal oxide grains with respect to a minor axis, that is, the ratio of major axis/minor axis is 3 to 50.

A fifth aspect of the present invention is a supporting material, wherein a haze value of the supporting material is 1.0 or less.

A sixth aspect of the present invention is a supporting material, wherein at least one of the antistatic layer and the protective layer is formed by applying a liquid film on the substrate and drying the film at the temperature in a range from 120 to 140° C.

A seventh aspect of the present invention is a silver halide photographic photosensitive material having a silver halide photographic photosensitive layer on a surface of a supporting material opposite to a side at which an antistatic layer and a protective layer are formed, wherein a surface electrical resistance value on the surface of the silver halide photographic photosensitive layer is in a range from 8×10⁷ to 6×10⁹ Ω.

An eighth aspect of the present invention is a photosensitive transfer material having a photosensitive resin layer on a surface of a supporting material opposite to a side at which an antistatic layer and a protective layer are formed.

### DESCRIPTION OF THE PREFERRED EMBODIMENTS

A supporting material of the present invention is prepared by sequentially forming, on one surface of a substrate, an antistatic layer containing acicular metal oxide grains, and a protective layer containing an epoxy cross linking agent and a sulfate ester-based surface active agent. Further, silver halide photographic photosensitive material and photosensitive transfer material of the present invention are each comprised of the supporting material of the present invention.

The supporting material of the present invention will be first described hereinafter in detail, and the silver halide photographic photosensitive material and photosensitive transfer material of the present invention will be described, in that order, in detail.

### Supporting Material

The supporting material of the present invention has an antistatic layer and a protective layer formed sequentially on one surface of a substrate, and if necessary, it may have other layers such as an undercoat layer.

The supporting material in the present invention is a plate-shaped material in which the antistatic layer and the protective layer are provided on the substrate.

### Antistatic Layer

The antistatic layer contains at least acicular metal oxide grains, and generally, further contains a binder. If necessary, the antistatic layer may also contain other components such as a matting agent, a surface active agent, and a lubricating agent.

### Metal Oxide Grains

As the above-described metal oxide grains, acicular metal oxide grains are used. For example, ZnO, TiO₂, SnO₂, Al₂O₃, In₂O₃, MgO, BaO, MoO₃, and composite oxides thereof, metal oxide having a small amount of heteroatoms contained therein, and the like are used.

Among them, SnO₂, ZnO, Al₂O₃, TiO₂, In₂O₃ and MgO are preferable, and SnO₂, ZnO, In₂O₃, and TiO₂ are more preferable, and further, SnO₂ is particularly preferable.

Examples of the metal oxide containing a small amount of heteroatoms include ZnO doped with a small amount of Al or In, TiO₂ doped with a small amount of Nb or Ta, In₂O₃ doped with a small amount of Sn, SnO₂ doped with a small amount of Sb, Nb or halogen atom.

A dope amount of heteroatoms to be doped for the metal oxide is preferably in a range from 0.01 to 30 mol %, and more preferably in a range from 0.1 to 10 mol %. If the dope amount of the above-described heteroatoms is less than 0.1 mol %, electric conductivity may not be sufficiently imparted to oxide or composite oxide. If the dope amount exceeds 30 mol %, the degree of blackening of the metal oxide grains increases so that the antistatic layer may become dark. As a result, the metal oxide thus obtained may not be suitable for the purpose of being applied to silver halide photographic photosensitive material or photosensitive transfer material.

Further, any material having oxygen deficiency in a crystal structure thereof is also preferable.

Among the metal oxide containing a small amount of heteroatoms, SnO₂ grains doped with antimony is preferable, and SnO₂ grains doped with 0.2 to 2.0 mol % of antimony is particularly preferable.

The grain size of the acicular metal oxide grains is set such that the ratio of the major axis to the minor axis is preferably in a range from 3 to 50, and particularly preferably in a range from 10 to 50.

The minor-axis length of the acicular grains is preferably in a range from 0.001 to 0.1 μm, and particularly preferably in a range from 0.01 to 0.02 μm. The major-axis length thereof is preferably in a range from 0.01 to 5.0 μm, and particularly preferably in a range from 0.1 to 2.0 μm.

In the present invention, an antistatic layer having excellent electric conductivity and antistatic ability and also having a low haze value and excellent transparency can be formed by particularly using metal oxide grains such as antimony-doped SnO₂, which has the above-described grain size (ratio of the major axis to the minor axis) and major-axis and minor-axis lengths.

That is, the above-described antistatic layer is useful for preparing a silver halide photographic photosensitive material having a haze value of 1.0 or less, in which a surface electrical resistance on the surface of a silver halide photographic photosensitive layer is in a range from 8×10⁷ to 6×10⁹ Ω. The silver halide photographic photosensitive material will be described later in detail.

The surface electrical resistance value is a value measured in accordance with a method described in the resistivity section of JIS-K-6911-1979, and the haze value is a value measured in accordance with a method described in the cloud value section of JIS-K-6714-1977.

Next, the reason why the antistatic layer having excellent electric conductivity and antistatic ability and also having a low haze value and excellent transparency can be formed by using acicular metal oxide grains having the above-described minor-axis and major-axis dimensions will be considered.

The above-described acicular metal oxide grains in the antistatic layer is provided in such a manner that the major axis thereof extends parallel to the surface of the antistatic layer and the thickness of the antistatic layer is merely the diametrical dimension of the minor axis of the grains. The acicular metal oxide grains are, as described above, made longer in the direction along the major axis thereof. Therefore, as compared with conventional spherical grains, the above-described grains are apt to contact each other and a high electric conductivity is obtained even with a small amount of grains. Accordingly, it is considered that the surface electrical resistance can be reduced without impairing the transparency.

Further, in the above-described acicular metal oxide grains, usually, the diameter of the minor axis is substantially equal to, or smaller than the thickness of the antistatic layer, and the minor axis does not protrude from the surface of the layer in most cases. Even if the minor axis protrudes from the layer, the protruding portion is small. Therefore, the protruding portion is almost completely covered by a protective layer provided on the antistatic layer. Accordingly, it is possible to prevent occurrence of white-powder contamination caused by the falling off of metal oxide grains protruding from the antistatic layer during conveying of the supporting material in a manufacturing process, during photographing when handled as the silver halide photographic photosensitive material or photographic transfer material, and during conveying in development processing.

Moreover, after the grains have been formed into the silver halide photographic photosensitive material or photosensitive transfer material, when the above-described acicular metal oxide is used, the variation between the surface electrical resistances before and after development processing is extremely small as compared with a case in which spherical grains are used. Particularly, conveying efficiency after the development processing is remarkably improved. The reason is, it is supposed, that in the case of spherical grains, the state of arrangement is apt to change due to swelling and contraction of a film caused by the development processing and an area in which the grains contact each other decreases as compared with the acicular grains.

Further, the film membrane strength of the antistatic layer can be increased by using the above-described acicular metal oxide, and it is possible to prevent the above-described falling-off of the antistatic agent during conveying in the manufacturing process or at the time of handling, during development, and during removal from a camera or the like, that is, so-called white-powder contamination.

The amount of metal oxide grains contained in the antistatic layer is preferably in a range from 10 to 1000 mass % based on the total mass of a binder, which will be described later (for example, when a hardened material of the following polymer and melamine compound is used, the total mass of the polymer and melamine compound), and more preferably in a range from 200 to 600 mass %. If the content is less than 10 mass %, sufficient antistatic ability may not be obtained. If the content exceeds 1000 mass %, the haze value becomes higher and transparency may remarkably deteriorate.

Further, in addition to the above-described acicular metal oxide grains, a well-known antistatic agent which can be used for a silver halide photographic photosensitive layer described later may also be used together as the antistatic agent.

### Binder

The antistatic layer is generally made to contain a binder for the purpose of dispersing and fixing metal oxide grains.

Examples of the binder include various polymers such as acrylic resin, vinyl resin, polyurethane resin and polyester resin. From the standpoint of preventing white-powder contamination, hard material formed of a polymer (preferably, acrylic resin, vinyl resin, polyurethane resin or polyester resin) and a melamine compound is preferably used.

Particularly, from the standpoint of maintaining a satisfactory working environment and preventing air pollution, water soluble or water-dispersed (emulsion) polymer and a melamine compound are preferable.

Further, the above-described polymer preferably has any one of a methylol group, a hydroxyl group, a carboxyl group and a glycidyl group so as to allow crosslinking reaction with a melamine compound. Among these groups, a hydroxyl group and a carboxyl group are more preferable, and a carboxyl group is particularly preferable.

An amount of the group (preferably, a hydroxyl group or a carboxyl group) existing in the polymer is preferably 0.0001 to 1 equivalent/1 kg, and particularly preferably 0.001 to 1 equivalent/1 kg.

Examples of the acrylic resin include homopolymers of any one of monomers such as acrylic acid, acrylic esters such as alkyl acrylate, acrylamide, acrylonitrile, methacrylic acid, methacrylic esters such as alkyl methacrylate, methacrylamide and methacrylonitrile, and copolymers obtained by polymerization of two or more kinds of these monomers. Among them, homopolymers of one of monomers, which include acrylic esters such as alkyl acrylate and methacrylic esters such as alkyl methacrylate, or copolymers obtained by polymerization of two or more kinds of these monomers are preferable. For example, homopolymers of one of monomers, which include acrylic esters and methacrylic esters, each having 1 to 6 carbon atoms, or copolymers obtained by polymerization of two or more kinds of these monomers can be used.

The above-described acrylic resin contains, as a principal component, the above-described composition, and is a polymer obtained by partially using a monomer having any one of, for example, a methylol group, a hydroxyl group, a carboxyl group and a glycidyl group so as to allow cross-linking reaction with a melamine compound.

Examples of the vinyl resin include polyvinyl alcohol, acid-modified polyvinyl alcohol, polyvinyl formal, polyvinyl butyral, polyvinyl methyl ether, polyolefin, ethylene/butadiene copolymer, polyvinyl acetate, vinyl chloride/vinyl acetate copolymer, vinyl chloride/(meth)acrylic ester copolymer and ethylene/vinyl acetate-based copolymer (preferably, ethylene/vinyl acetate/ (meth)acrylic ester copolymer). Among them, polyvinyl alcohol, acid-modified polyvinyl alcohol, polyvinyl formal, polyolefin, ethylene/butadiene copolymer, and ethylene/vinyl acetate-based copolymer (preferably, ethylene/vinyl acetate/acrylic ester copolymer) are preferable.

In the above-described vinyl resin, in order to allow crosslinking reaction with a melamine compound, polyvinyl alcohol, acid-modified polyvinyl alcohol, polyvinyl formal, polyvinyl butyral, polyvinyl methyl ether and polyvinyl acetate are each made into a polymer having a hydroxyl group by, for example, allowing a vinyl alcohol unit to remain therein. Other polymers are each made into a polymer which allows crosslinking by, for example, partially using a monomer having any one of a methylol group, a hydroxyl group, a carboxyl group, and a glycidyl group.

Examples of the polyurethane resin include a polyhydroxy compound (such as ethylene glycol, propylene glycol, glycerine or trimethylol propane), any one kind of aliphatic polyester-based polyol obtained by reaction between a polyhydroxy compound and polybasic acid, polyether polyol (such as poly(oxypropylene ether)polyol or poly(oxyethylene-propylene ether) polyol), polycarbonate-based polyol and polyethylene terephthalate polyol, and polyurethane derived from a mixture of these compounds and polyisocyanate.

In the above-described polyurethane resin, for example, after polyol and polyisocyanate are reacted with each other, a remaining unreacted hydroxyl group can be utilized as a functional group which allows a crosslinking reaction with a melamine compound.

An example of the above-described polyester resin is generally a polymer obtained by reaction between a polyhydroxy compound (for example, ethylene glycol, propylene glycol, glycerine, trimethylol propane or the like) and a polybasic acid.

In the above-described polyester resin, for example, after the polyol and polybasic acid are reacted with each other, a hydroxyl group and a carboxyl group remaining in a unreacted state can be utilized as a functional group which allows a crosslinking reaction with a melamine compound. A third component having a functional group such as a hydroxyl group may naturally be added.

Among the above-described polymers, acrylic resin and polyurethane resin are preferable, and acrylic resin is particularly preferable.

Examples of the above-described melamine compound include a compound containing two or more (preferably, three or more) methylol groups and/or alkoxymethyl group in a melamine molecule, a melamine resin which is a polycondensation product of the groups, and a melamine/urea resin. Examples of an initial condensation product of melamine and formalin include dimethylol melamine, trimethylol melamine, tetramethylol melamine, pentamethylol melamine and hexamethylol melamine. For example, Sumitex Resin M-3, MW, MK and MC (manufactured by Sumitomo Chemical Co., Ltd.) and the like are marketed products, but the present invention is not limited to the same.

Examples of the melamine resin which is the polycondensation product include hexamethylolmelamine resin, trimethylolmelamine resin, trimethyloltrimethoxymethylmelamine resin and the like. For example, MA-1 and MA-204 (manufactured by Sumitomo Bakelite Co., Ltd.), Beckamine MA-S, Beckamine APS, Beckamine J-101 (manufactured by Dainippon Ink & Chemicals, Inc.), UROID 344 (manufactured by Mitsui Toatsu Chemicals, Inc.), Ohshika Resin M31 and Ohshika Resin PWP-8 (manufactured by Ohshika Shinko Co., Ltd.) and the like are commercial products. However, the present invention is not limited to the same.

The melamine compound according to the present invention preferably has a functional group equivalent (represented by a value into which a molecular weight is divided by the number of functional groups in one molecule) of 50 to 300. The functional group mentioned herein refers to a methylol group and/or an alkoxymethyl group.

If the functional group equivalent is less than 50, the hardening density becomes higher, but transparency is impaired. Even if the amount of the melamine compound is reduced, the transparency may not become better. If the functional group equivalent exceeds 300, the hardening density is low and a high strength may not be obtained. If the amount of melamine compound is increased, coating efficiency deteriorates. Further, if the hardening density is low, abrasion is apt to occur and holding power of metal oxide is also reduced.

The above-described melamine compound may be used singly or may be used in a combination of two or more.

The amount of the melamine compound added is preferably 0.1 to 100 mass % based on the mass of the above-described polymer, and more preferably 10 to 90 mass %.

The above-described melamine compound can also be used together with other compounds. Examples of the other compounds include curing agents described in “The Theory of the Photographic Process”, the 3rd edition (1966) by C. E. K. Meers and T. H. James, U.S. Pat. Nos. 3,316,095, 3,232,764, 3,288,775, 2,732,303, 3,635,718, 3,232,763, 2,732,316, 2,586,168, 3,103,437, 3,017,280, 2,983,611, 2,725,294, 2,725,295, 3,100,704, 3,091,537, 3,321,313, 3,543,292 and 3,125,449, British Patent Nos. 994,869 and 1,167,207, and the like.

Typical examples of the curing agent include aldehyde-based compounds such as mucochloric acid, mucobromic acid, mucophenoxy chloric acid, mucophenoxy bromic acid, formaldehyde, glyoxal, monomethylglyoxal, 2,3-dihydroxy-1,4-dioxane, 2,3-dihydroxy-5-methyl- 1,4-dioxanesuccinaldehyde, 2,5-dimethoxytetrahydrofuran, and glutaraldehyde, and derivatives thereof; active vinyl-based compounds such as divinylsulfone-N,N′-ethylenebis(vinylsulfonylacetamide), 1,3-bis (vinylsulfonyl)-2-propanol, methylenebismaleimide, 5-acetyl-1,3-diacryloyl-hexahydro-s-triazine, 1,3,5-triacryloyl-hexahydro-s-triazine and 1,3,5-trivinylsulfonyl-hexahydro-s-triazine; active halogen-based compound such as 2,4-dichloro-6-hydroxy-s-triazine sodium salt, 2,4-dichloro-6-(4-sulfoanilino)-s-triazine sodium salt, 2,4-dichloro-6-(2-sulfoethylamino)-s-triazine and N,N′-bis(2-chloroethylcarbamoyl)piperazine; epoxy compounds such as bis(2,3-epoxypropyl)methylpropyl ammonium.p-toluene sulfonate, 1,4-bis(2′,3′-epoxypropyloxy)butane, 1,3,5-triglycidylisocyanurate, sorbitolpolyglycidyl ethers, polyglycerolpolyglycidyl ethers, pentaerythritolpolyglycidyl ethers, diglycerolpolygrlycidyl ethers, 1,3,5-triglycidyl(2-hydroxyethyl)isocyanurate, glycerolpolyglycerol ethers and trimethylolpropane polyglycidyl ethers; ethylenimine-based compounds such as 2,4,6-triethylene-s-triazine, 1,6-hexamethylene-N,N′-bisethylene urea and bis-β-ethyleniminoethylthio ether; methane sulfonate ester-based compounds such as 1,2-di(methanesulfonoxy)ethan, 1,4-di(methanesulfonoxy)butane and 1,5-di(methanesulfonoxy)pentane; carbodiimide compounds such as dicyclohexylcarbodiimide and 1-dicyclohexyl-3-(3-trimethylaminopropyl) carbodiimide hydrochloride; isoxazole-based compounds such as 2,5-dimethylisoxazole; inorganic compounds such as chrome alum and chromium acetate; dehydro-condensed peptide reagent such as N-carboethoxy-2-isopropoxy-1,2-dihydroquinoline and N-(1-morpholinocarboxy)-4-methylpyridiumchloride; active ester-based compounds such as N,N′-adipoyldioxydisuccinimide and N,N′-terephthaloyldioxydisuccinimide; isocyanates such as toluene-2,4-diisocyanate and 1,6-hexamethylenediisocyanate; and epichlorohydrin-based compounds such as polyamide-polyamine-epichlorohydrin reactant. However, the present invention is not limited to these compounds.

The amount of the binder contained in the antistatic layer is preferably in a range from 5 to 100 mg/m², and more preferably in a range from 10 to 25 mg/m². If the content is less than 5 mg/m², sufficient film membrane strength may not be obtained. If the content is more than 100 mg/m², coagulation of metal oxide grains is caused and stability of coating liquid may be impaired.

### Other Components

The above-described antistatic layer may, if necessary, also include other components such as a matting agent, a surface active agent, and a lubricating agent so long as the effects of the present invention may not be damaged.

Examples of the matting agent include grains of oxides such as silicon oxide, aluminum oxide and magnesium oxide, having a grain size of 0.001 to 10 μm, grains of polymer or copolymer, for example, polymethylmethacrylate, polystyrene or the like.

Examples of the above-described surface active agent include well-known anion-based surface active agents, cation-based surface active agents, ampholytic surface active agents and non-ionic surface active agents.

Examples of the lubricating agent include phosphoric ester of higher alcohol having 8 to 22 carbon atoms, or amino salt thereof; palmitic acid, stearic acid, behenic acid, and esters thereof; and silicone-based compound.

The antistatic layer can be formed on the substrate, for example, in such a manner as described below.

First, the metal oxide grains in an unchanged state or in a state of a dispersed liquid in which the grains are dispersed in a solvent such as water (if necessary, containing a dispersant and a binder) are added to water dispersed liquid or aqueous solution, which contains the above-described binder (for example, a polymer, a melamine compound, and appropriate additives) and mixed (if necessary, dispersed), thereby preparing a coating liquid for forming an antistatic layer (which may be hereinafter referred to as “coating liquid for an antistatic layer”).

The above-described coating liquid for an antistatic layer is applied to the surface of the above-described plastic film substrate such as polyester (the surface with no photosensitive layer formed thereon) by any well-known coating method and dried, thereby forming an antistatic layer.

Examples of the above-described well-known coating method include dip coating, air knife coating, curtain coating, wire bar coating, gravure coating, and extrusion coating.

Since the coating film is an aqueous liquid film, it is advantageous to carry out drying after the coating in, for example, an atmosphere in which the maximum temperature during drying becomes 170° C. or higher from the standpoint of drying rate and the like. However, in the present invention, the drying temperature (the temperature range from an initial temperature of drying to the maximum temperature) is preferably 120 to 140° C. from the standpoint of film-forming efficiency of a coated liquid film. In this temperature range, the film membrane strength can be increased.

The layer thickness of the antistatic layer is preferably 0.01 to 1 μm, and more preferably 0.01 to 0.2 μm. If the layer thickness is less than 0.01 μm, it is difficult to uniformly apply the coating liquid, and coating unevenness is apt to occur. If the thickness is more than 1 μm, the antistatic ability, scratch resistance, and film membrane strength may be deteriorated.

### Protective Layer

A protective layer is provided on the antistatic layer for the purpose of mainly improving lubricating properties and scratch resistance, and assisting in preventing falling of metal oxide grains from the antistatic layer.

The protective layer contains at least an epoxy crosslinking agent and a sulfate ester-based surface active agent represented by CₙH₂ₙ₊₁OSO₃Na (n represents an integer of 12 to 18). Generally, it also contains polyolefin, and if necessary, may also contain other components such as a matting agent, a surface active agent, a lubricating agent and the like.

### Epoxy Crosslinking Agent

The protective layer contains an epoxy crosslinking agent. Due to the protective layer containing an epoxy crosslinking agent, the film membrane strength of the protective layer itself, which is the outermost layer, can be improved. Further, peeling resistance of the antistatic layer interposed between the substrate and the protective layer is improved and falling-off of the antistatic agent is also prevented. Accordingly, white-powder contamination, deterioration of a developing solution, maintenance burden of an automatic processor, as described above, can be avoided and alleviated.

Examples of the above-described epoxy crosslinking agent include monofunctional and multifunctional epoxy compounds having an epoxy functional group. For example, sorbitol polyglycidyl ether, sorbitan polyglycidyl ether, polyglycerol polyglycidyl ether, pentaerythritol polyglycidyl ether, diglycerol polyglycidyl ether, triglycidyl tris(2-hydroxyethyl) isocyanurate, glycerol polyglycidyl ether, trimethylolpropane polyglycidyl ether, resorcinol diglycidyl ether, neopentylglycol diglycidyl ether, 1,6-hexanediol diglycidyl ether, ethyleneglycol diglycidyl ether and polyethyleneglycol diglycidyl ether are used. DENACOL products manufactured by Nagase Kasei Kogyo Co., Ltd. (for example, DENACOL EX-313, EX-314, EX-421, EX-512, EX-521, EX-611, EX-614 and EX-622) and the like are commercial products.

Among these compounds, an epoxy crosslinking agent of which average epoxy function group in a molecule is 4.5 to 6.5, is preferably used in the present invention from the standpoint of improving the film membrane strength and effectively preventing falling of the antistatic agent from the antistatic layer. Products of such epoxy crosslinking agents are practically placed on the market as, for example, DENACOL EX-521 manufactured by Nagase Kasei Kogyo Co., Ltd..

The amount of the epoxy cross-linking agent coated is preferably in a range from 5 to 100 mg/m², and more preferably in a range from 10 to 25 mg/m².

If the amount of coating is less than 5 mg/m², sufficient film membrane strength is not obtained, and peeling-off of a film or falling-off of the antistatic agent may not be prevented due to contact friction during conveying and the like. If the amount of coating is more than 100 mg/m², coagulation of metal oxide grains may result in ununiform formation of a coating film.

### Sulfate Ester-based Surface Active Agent

The protective layer contains a sulfate ester-based surface active agent. Due to the sulfate ester-based surface active agent being contained in the protective layer, the surface of the protective layer is made smooth and lubricating properties can be improved. As a result, occurrence of contact defects, for example, in a manufacturing process or when it is being handled as silver halide photographic photosensitive material or the like (removal from a camera, and the like) can be prevented (that is, scratch resistance can be improved).

As the above-described sulfate ester-based surface active agent, a sulfate ester-based surface active agent represented by the following formula is used:

CₙH₂ₙ₊₁OSO₃Na,

wherein, n represents an integer of 12 to 18, preferably an integer of 14 to 16.

Specific examples of the sulfate ester-based surface active agent represented by the above-described formula include hexadecyloxysodium sulfonic acid and tetradecyloxysodium sulfonic acid. However, the present invention is not limited to the same.

The amount of the sulfate ester-based surface active agent to be coated is preferably in a range from 2.0 to 10.0 mg/m², and more preferably in a range from 4.0 to 8.0 mg/m².

If the amount of coating is less than 2.0 mg/m², scratch resistance may not be sufficiently improved. If the amount of coating is more than 10.0 mg/m², the layer may become cloudy, or wettability of a surface opposite to the coating surface may be adversely affected by transfer.

### Polyolefin

Examples of the above-described polyolefin include:

(1) wax, resin and rubber-like materials comprised of homopolymer or copolymer of 1-olefin based unsaturated hydrocarbon such as ethylene, propylene, 1-butene and 4-methyl-1-pentene (for example, polyethylene, polypropylene, poly-1-butene, poly-4-methyl-1-pentene, ethylene/propylene copolymer, ethylene/1-butene copolymer and propylene/1-butene copolymer);

(2) rubber-like copolymers of at least two kinds of the above-described 1-olefin and conjugated or non-conjugated diene (for example, ethylene/propylene/ethylidenenorbornene copolymer, ethylene/propylene/1,5-hexadiene copolymer, and isobutene/isoprene copolymer);

(3) copolymers of the above-described 1-olefin and conjugated or non-conjugated diene (for example, ethylene/butadiene copolymer and ethylene/ethylidenenorbornene copolymer);

(4) the above-described 1-olefin (particularly, ethylene/vinyl acetate copolymer, and perfect or partial saponified substances thereof); and

(5) graft polymer obtained by grafting the above-described conjugated or non-conjugated diene, vinyl acetate or the like in homopolymer or copolymer of the above-described 1-olefin with, and perfect or partial saponified substances thereof. However, the present invention is not limited to these compounds. These compounds are described in Japanese Patent Application Publication (JP-B) No. 5-41656.

Among the above-described examples of polyolefin, those having a carboxyl group and/or carboxylic acid base is preferable. Usually, the polyolefin can be used as aqueous solution or water dispersed liquid.

The amount of the polyolefin to be coated is preferably in a range from 10 to 50 mg/m², and more preferably in a range from 20 to 30 mg/m². If the amount of coating is less than 10 mg/m², scratch resistance may not be sufficiently improved. If the amount of coating is more than 50 mg/m², coating unevenness or liquid film repellency may occur frequently.

### Other Components

In addition to the above-described components, water soluble methyl cellulose having a methylation of 2.5 or less may also be added to the protective layer. The amount of the water soluble methyl cellulose to be added is preferably in a range from 0.1 to 40 mass % based on the mass of the polyolefin contained in the protective layer. The water soluble methyl cellulose is described in Japanese Patent Application Laid-Open (JP-A) No. 1-210947.

Further, in the protective layer as well, other components used in the antistatic layer (i.e., a matting agent, a surface active agent, a lubricating agent and the like) may also be used together as occasion demands.

The protective layer can be formed on the antistatic layer, for example, in such a manner as described below.

The protective layer can be formed by, for example, a well-known coating method. First, the above-described epoxy crosslinking agent, sulfate ester-based surface active agent, polyolefin, and if necessary, other components are dissolved and dispersed in a solvent such as water, to thereby prepare a coating liquid for forming a protective layer (which may be hereinafter referred to as “coating liquid for a protective layer”). The coating liquid for a protective layer is applied onto the surface of the antistatic layer by a well-known coating method and dried, thereby forming the protective layer.

As the above-described well-known coating method, the coating methods as described in formation of the antistatic layer can also be applied. The drying temperature after coating (that is, the temperature range from an initial temperature of drying to the maximum temperature) is preferably 120 to 140° C. due to the same reason as in formation of the antistatic layer. Due to the drying temperature being set in the above-described range, the film membrane strength can be increased.

The thickness of the protective layer is preferably in a range from 0.01 to 1 μm due to the same reason as in the antistatic layer, and more preferably in a range from 0.01 to 0.2 μm.

### Substrate

The above-described substrate is preferably a plastic film. Examples thereof include films of polyethylene terephthalate, polyethylene naphthalate, cellulose triacetate, cellulose acetate butylate, cellulose acetate propionate, polycarbonate, polystyrene and polyethylene.

The above-described plastic film may be used before successive biaxial drawing, before simultaneous biaxial drawing, after uniaxial drawing and before redrawing, or after biaxial drawing.

Among the above-described films, a polyethylene terephthalate film is preferable, and a biaxial-drawing and thermally-fixed polyethylene terephthalate film is particularly preferable from the standpoint of stability and toughness.

The thickness of the substrate is not particularly limited, and generally in a range from 15 to 500 μm. Particularly, the thickness is preferably in a range from 40 to 200 μm from the standpoint of handling characteristics and the ability to be used extensively.

The substrate may contain dyeable silicon, alumina sol, chromium salt, zirconium salt or the like so long as the transparency thereof can be maintained.

Further, in a case in which the substrate is made into a surface on which the coating liquid for an antistatic layer is applied (that is, a reverse side) and also into silver halide photographic photosensitive material or photosensitive transfer material, a surface of the substrate (opposite to the reverse side) on which a coating liquid for forming a silver halide photographic photosensitive layer or a coating liquid for forming a photosensitive resin layer, which will be described later, is applied, is preferably subjected in advance to surface active treatment such as chemical treatment, mechanical treatment, corona discharge treatment, flame treatment, ultraviolet treatment, high-frequency treatment, glow discharge treatment, active plasma treatment, laser treatment, mixed acid treatment or ozone acid treatment for the purpose of allowing secure adhesion of each layer to the surface of the substrate.

For example, in a case in which silver halide photographic photosensitive material is prepared by applying a coating liquid for forming a silver halide photographic photosensitive layer (which may be hereinafter referred to as “coating liquid for a silver halide photographic photosensitive layer”), in order to ensure adhesiveness between the substrate and the layer, the following methods are proposed:

(1) a method in which after the above-described surface active treatment, the coating liquid for a silver halide photographic photosensitive layer is directly applied to the surface of the substrate to thereby obtain adhesive force; and

(2) a method in which after the above-described surface active treatment, an undercoat layer is provided and the coating liquid for a silver halide photographic photosensitive layer is applied to the undercoat layer. Among these methods, the method (2) is more effective and used widely.

It is considered that improvement of adhesiveness by the above-described surface active treatment is achieved in either treatment by forming at least one polar group on the surface of the substrate, which essentially has hydrophobic property, and removing a thin layer which adversely affects adhesion of the surface, and further increasing crosslinking density of the surface to increase adhesive force. Accordingly, it is considered that, adhesiveness between the undercoat layer and the surface of the substrate can be improved due to, for example, an increase of affinity with a polar group of components contained in a solution for forming an undercoat layer, or an increase of fastness of the adhesive surface.

In the above-described method (2), the undercoat layer is structured by, for example, a so-called multilayer system in which a layer having a high adhesiveness for the substrate (first undercoat layer) is provided as a first layer and a gelatin layer (second undercoat layer) is formed on the first layer, or a single layer system in which a single resin layer containing both hydrophobic and hydrophilic groups.

In order to form the undercoat layer, for example, a method is used, wherein a two-layer undercoat layer comprised of a first undercoat layer containing high polymer and a second undercoat layer containing gelatin, is formed by applying an aqueous coating liquid (that is, a coating liquid for forming the first undercoat layer or the second undercoat layer).

Examples of the high polymer contained in the first undercoat layer include copolymers having, as starting material, a monomer selected from a group consisting of vinyl chloride, vinylidene chloride, butadiene, metacrylic acid, acrylic acid, itaconic acid, maleic anhydride and the like, polyethylene imine, epoxy resin-graft gelatin and nitrocellulose.

Further, the above-described first undercoat layer may, if necessary, include, as a swelling agent, for example, phenol, resorcin or the like added thereto. The amount of addition is preferably in a range from 1 to 10 g per liter of the coating liquid for forming the first undercoat layer.

In addition, hydrophilic polymer, blocking inhibitor, methylcellulose or polyvinyl alcohol may also be added to the first undercoat layer.

Examples of the above-described hydrophilic polymer include natural polymers such as gelatin, and synthetic polymer such as polyvinyl alcohol, vinyl acetate/maleic anhydride copolymer, acrylic acid-acrylamide copolymer and styrene/maleic anhydride copolymer. Examples of the above-described blocking inhibitor include a matting agent such as silicon dioxide, polymethyl acrylate and polystyrene.

Further, in both the first undercoat layer and the second undercoat layer, generally, a hardening agent such as dichlorotriazine derivatives or epoxy compound is used.

The coating liquid for forming the first undercoat layer can be applied by, for example, a well-known coating method such as dip coating, air knife coating, curtain coating, roller coating, wire bar coating, gravure coating or the like, or extrusion coating using a hopper, which is described in U.S. Pat. No. 2,681,294. When the second undercoat layer is provided on the first undercoat layer, if necessary, the second or subsequent layers can be applied at the same time by a method described in U.S. Pat. Nos. 2,761,791, 3,508,947, 2,941,898 and 3,526,528, or described in “Coating Technology” by Hitoshi Ozaki (issued by Asakura Shoten in 1973; p. 253) or the like.

The amount of the first undercoat layer and the second undercoat layer to be coated is preferably in a range from 0.01 to 10 g/m² of a polyester film substrate in a solid form, and more preferably in a range from 0.2 to 3 g/m².

Generally, a hydrophilic colloid layer containing gelatin as a main component, is provided, as the second undercoat layer, on the first undercoat layer.

Examples of the hydrophilic polymer which can be used for the second undercoat layer include, in addition to gelatin, synthetic or natural hydrophilic high molecular compounds, for example, acylated gelatin such as phthalic gelatin or maleic gelatin, cellulose derivatives such as carboxymethyl cellulose or hydroxyethyl cellulose, graft gelatin obtained by grafting acrylic acid, metacrylic acid or amide in gelatin, homopolymer or copolymer of polyvinyl alcohol, polyhydroxy alkylacrylate, polyvinyl pyrolidone, vinyl pyrolidone/vinyl acetate copolymer, casein, agarose, albumin, alginate soda, polysaccharide, agar, starch, graft starch, polyacrylamide, polyethylenimine acyl compound, acrylic acid, methacrylic acid acrylamide, N-substituted acrylamide or N-substituted methacrylamide, or partial hydrolysates thereof.

These compounds may be used singly or may be used in a combination of two or more. Further, the above-described hydrophilic polymer can also include, if necessary, an antistatic agent, a crosslinking agent, a matting agent, a blocking inhibitor and the like.

As described above, the acicular metal oxide grains are contained in the antistatic layer and the epoxy crosslinking agent and sulfate ester-based surface active agent are contained in the protective layer. Therefore, a stably high antistatic ability is obtained before and after development processing while maintaining a high transparency, and the film membrane strength of each of the antistatic layer and protective layer can also be improved. As a result, peeling-off of a layer and falling-off of the antistatic agent can be effectively prevented. White-powder contamination of a substrate and the like, adhesion of foreign matters, and deterioration of a developing solution can also be avoided, and operational burden such as cleaning of an automatic processor can be reduced.

### Silver Halide Photographic Photosensitive Material

The silver halide photographic photosensitive material of the present invention is formed by using the above-described supporting material of the present invention, and has at least a silver halide photographic photosensitive layer on the surface thereof with none of antistatic layer and protective layer provided thereon, and if necessary, has also a non-photosensitive photographic component layer such as an undercoat layer comprised of a single layer or plural layers.

### Silver Halide Photographic Photosensitive Layer

The above-described silver halide photographic photosensitive layer (and/or other photographic component layers) may contain, as a binder, various hydrophilic colloids.

Examples of the above-described hydrophilic colloids include gelatin, colloidal albumin, casein, cellulose derivatives such as calboxymethyl cellulose and hydroxyethyl cellulose, agar, alginate soda, sugar derivatives such as starch derivatives, synthetic hydrophilic colloid, for example, polyvinyl alcohol, poly N-vinylpyrolidone, polyacrylic acid copolymer, polyacrylamide, derivatives thereof, and partial hydrolytic sugar. A compatible mixture comprised of two or more kinds of these colloids is used as occasion demands.

Among these colloids, gelatin is generally used.

In the silver halide photographic photosensitive layer, a synthetic polymer compound, for example, a latex-like water dispersion vinyl compound polymer, particularly, a compound for increasing dimensional stability of photographic material may also be contained singly. Alternatively, more than one different types of synthetic polymer compounds may also be contained in such a manner as to be mixed or combined with a water-permeable hydraulic colloid.

Examples of the above-described synthetic polymer compound are described in, for example, U.S. Pat. Nos. 2,376,005, 2,739,137, 2,853,457, 3,062,674, 3,411,911, 3,488,708, 3,525,620, 3,635,715, 3,607,290 and 3,645,740, and British Patent Nos. 1,186,699 and 1,307,373.

Among the compounds described therein, copolymers and homopolymers selected from a group consisting of alkylacrylate, alkylmethacrylate, acrylic acid, methacrylic acid, sulfoalkylacrylate, sulfoalkylmethacrylate, glycidyl acrylate, glycidyl methacrylate, hydroxyalkylacrylate, hydroxyalkylmethacrylate, alkoxyalkylacrylate, alkoxyalkylmethacrylate, styrene, butadiene, vinyl chloride, vinylidene chloride, maleic anhydrate and itaconic anhydrate are generally used.

The silver halide photographic photosensitive layer is subjected to hardening treatment by an ordinary method. Examples of a hardening agent used for the hardening treatment include aldehyde-based compounds such as formaldehyde and glutaraldehyde, ketone compounds such as diacetyl, cyclopentanedione, bis(2-chloroethyl urea), 2-hydroxy-4,6-dichloro-1,3,5-triazine, compounds having reactive halogen, described in U.S. Pat. Nos. 3,288,775 and 2,732,303, and British Patent Nos. 974,723 and 1,167,207, divinylsulfone, 5-acetyl-1,3-diacryloylhexahydro-1,3,5-triazine, compounds having reactive olefin, described in U.S. Pat. Nos. 3,635,718, 3,232,763, 3,490,911 and 3,642,486, and British Patent No. 994,869, N-hydroxymethylphthalimide, N-methylol compounds described in U.S. Pat. Nos. 2,732,316 and 2,586,168, isocynates described in U.S. Pat. No. 3,103,437 and the like, aziridine compounds described in U.S. Pat. Nos. 3,017,280 and 2,983,611, acid derivatives described in U.S. Pat. Nos. 2,725,294 and 2,725,295, carbodiimide-based compounds described in U.S. Pat. No.3,100,704 and the like, epoxy compounds described in U.S. Pat. No. 3,091,537 and the like, isoxazole-based compounds described in U.S. Pat. Nos. 3,321,313 and 3,534,292, halogenocarboxyaldehydes such as mucochloric acid, dioxane derivatives such as dihydroxydioxane and dichlorodioxane, N-carbamoylpyridinium salts, and haloamidinium salts. Examples of an inorganic hardening agent include chlome alum and zirconium sulfate.

In place of the above-described compounds, materials which are precursors, for example, alkali metal bisulfite aldehyde addition product, methylol derivative of hydantoin, and primary aliphatic nitroalcohol can also be used.

An emulsion for forming the silver halide photographic photosensitive layer (for example, a coating liquid for a silver halide photosensitive layer) is prepared as a silver halide emulsion in such a manner that, usually, a water soluble silver salt (for example, silver nitrate) solution and a water soluble halogen salt (for example, potassium bromide) solution are mixed together in the presence of a hydrophilic colloid (water soluble high polymer) solution such as gelatin. In this case, as the silver halide, mixed silver halide such as chlorinated silver, iodinated silver or silver chloroiodobromide may also be used in addition to silver chloride and silver bromide.

The above-described silver halide emulsion may include various compounds added thereto, for the purpose of preventing decrease of sensitivity or occurrence of fogging in a manufacturing process of silver halide photographic photosensitive material, or during storage or processing of the material.

As the compounds to be added, for example, 4-hydroxy-6-methyl-1,3,3a,7-tetrazaindene, 3-methyl-benzothiazole, 1-phenyl-5-mercaptotetrazol, and further, very many compounds such as well-known heterocyclic compounds, water-containing silver compounds, mercapto compounds and metallic salts are known.

The silver halide emulsion can be chemically sensitized by an ordinary method. Examples of a chemical sensitizer include gold compounds such as aurate chloride and gold trichloride, salts of precious metal such as platinum, palladium, iridium, rhodium and ruthenium, sulfur compounds which react with silver salt to form silver sulfide, primary stannic salt, amines and other reducing substances.

The silver halide emulsion can be, if necessary, subjected to spectral sensitization or supersensitization by using cyanine dyes such as cyanine, merocyanine or carbocyanine singly or in a combination of two or more, or by using a combination of the cyanine dyes and styryl dyes.

In the non-photosensitive photographic component layer such as the undercoat layer, stilbene, triazine, oxazole, coumarin-based compounds or the like may be contained as a whitening agent. Further, benzotriazole, thiazolidine, cinnamic acid ester-based compounds or the like may be contained as an ultraviolet absorbing agent, and various well-known photographic filter dyes may be contained as a light absorbing agent.

If necessary, the silver halide photographic photosensitive layer can contain, as a lubricating agent or adhesion inhibitor, for example, fatty acid amide or ester, and polyester which are described in U.S. Pat. Nos. 2,732,305, 4,042,399 and 3,121,060, and British Patent No. 1,466,304; water-insoluble substances described in British Patent Nos. 1,320,564 and 1,320,565, and U.S. Pat. No. 3,121,060; and surface active materials described in U.S. Pat. No. 3,617,286. The protective layer may contain, as the matting agent, silica having an appropriate grain size, inorganic compounds such as barium strontium sulfate, organic polymers such as polymethylmethacrylate and polystyrene, or the like.

Further, the silver halide photographic photosensitive layer can also contain, for example, hydrophilic polymer described in U.S. Pat. Nos. 2,725,297, 2,972,535, 2,972,536, 2,972,537, 2,972,538, 3,033,679, 3,072,484, 3,262,807, 3,525,621, 3,615,531, 3,630,743, 3,653,906, 3,655,384 and 3,655,386, and British Patent Nos. 1,222,154 and 1,235,075; hydrophobic polymer described in U.S. Pat. Nos. 2,973,263 and 2,976,148; biguanide compound described in U.S. Pat. Nos. 2,584,362 and 2,591,590; sulfonic acid type anion compound described in U.S. Pat. Nos. 2,639,234, 2,649,372, 3,201,251 and 3,457,076; phosphoric ester and quaternary ammonium salts described in U.S. Pat. Nos. 3,317,344 and 3,514,291; cationic compound described in U.S. Pat. Nos. 2,882,157, 2,982,651, 3,399,995, 3,549,369 and 3,564,043; nonionic compound described in U.S. Pat. No. 3,625,695; amphoteric compound described in U.S. Pat. No.3,736,268; complex compound described in U.S. Pat. No. 2,647,836; and organic salts described in U.S. Pat. Nos. 2,717,834 and 3,655,387.

A color photosensitive material using a dye forming coupler, or the like corresponds to the sliver halide photographic photosensitive material of the present invention. The color photosensitive material mentioned herein means general cinema films such as a color negative film, a reversal film, a color negative cinema film, a color positive film, and a positive cinema film.

A typical example of the color photosensitive material is a silver halide photographic photosensitive material in which photosensitive layers comprised of a plurality of silver halide photographic photosensitive layers having substantially different color sensitivities are formed on a surface of the supporting material of the present invention not having the antistatic layer and protective layer. The above-described photosensitive layers are formed in such a manner that unit photosensitive layers each having a color sensitivity for one of light of blue, green and red are provided in a layered form.

In the silver halide emulsion which constitutes the silver halide photographic photosensitive layer of the silver halide photographic photosensitive material used for general photographing, as silver halide, silver iodobromide, silver iodochloride and silver chlorobromide, having a silver iodide content of about 0.5 to 30 mol %, are suitably used. Among them, silver iodobromide or silver iodochlorobromide, having a silver iodide content of about 2 to 10 mol %, is particularly preferable.

Suitable silver halide used for the silver halide emulsion which constitutes a silver halide photographic photosensitive layer of a color positive cinema film, is silver chlorobromide or silver chloride. Among them, a silver halide emulsion having a silver chloride content of 9.5 mol % or greater and also containing silver bromide (silver iodide) for the rest, is preferable.

The silver halide emulsion can be prepared by the methods described in, for example, Research Disclosure (hereinafter abbreviated as RD) No. 17643 (December 1978), pages 22 to 23, “I. Emulsion preparation and types”, No. 18716 (November 1979), page 648, and No. 307105 (November 1989), pages 863 to 865; “Chemie et Phisique Photographique” by P. Glafkides, Paul Montel, 1967; “Photographic Emulsion Chemistry” by G. F. Duffin, Focal Press, 1966; and “Making and Coating Photographic Emulsion” by V. L. Zelikman et al., Focal Press, 1964.

Normally, the silver halide emulsion is used after being subjected to physical ripening, chemical ripening, and spectral sensitization. The additives to be used in these processes are described in RD Nos. 17643, 18716 and 307105 and the relevant references are summarized in the table below.

| | Additives | RD 17643 | RD 18716 | RD 307105 |
|---|---|---|---|---|
| 1 | Chemical sensitizers | page 23 | page 648, right | page 866 |
| | | | column | |
| 2 | Sensitivity raising | | page 648, right | |
| | agents | | column | |
| 3 | Spectral sensitizers, | pages 23 to 24 | page 648, right | pages 866 to |
| | Supersensitizers | | column to page | 868 |
| | | | 649, right | |
| | | | column | |
| 4 | Brighteners | page 24 | page 647, right | page 868 |
| | | | column | |
| 5 | Light absorbers, | pages 25 to 26 | page 649, right | page 873 |
| | filter dyes, | | column to page | |
| | ultraviolet absorbers | | 650, right | |
| | | | column | |
| 6 | Binders | page 26 | page 651, left | pages 873 to |
| | | | column | 874 |
| 7 | Plasticizers, | page 27 | page 650, right | page 876 |
| | lubricants | | column | |
| 8 | Coating aids, | pages 26 to 27 | page 650, right | pages 875 to |
| | surfactants | | column | 876 |
| 9 | Antistatic agents | page 27 | page 650, right | pages 876 to |
| | | | column | 877 |
| 10 | Matting agents | | | Pages 878 to |
| | | | | 879 |

Although various dye forming couplers can be used in the silver halide photographic photosensitive material of the present invention. Among them, the following couplers are particularly preferable.

Examples of yellow couplers include: couplers represented by formulae (I) and (II) in EP 502,424A; couplers (particularly Y-28 of page 18) represented by the formulae (1) and (2) in EP 513,496A; couplers represented by the general formula (I) in claim 1 of Japanese Patent Application Laid-Open (JP-A) No. 5-307248; couplers represented by the general formula (I) in column 1, lines 45 to 55, in U.S. Pat. No. 5,066,576; couplers represented by the general formula (I) in paragraph 0008 of JP-A No. 4-274425; couplers (particularly, D-35 on page 18) described in claim 1 on page 40 in EP 498,381A1; couplers (particularly, Y-1 (page 17) and Y-54 (page 41)) represented by the formula (Y) on page 4 in EP 447,969A1; and couplers (particularly, II-17 and II-19 (column 17), and II-24 (column 19)) represented by the formulae (II) to (IV) in column 7, lines 36 to 58, in U.S. Pat. No. 4,476,219.

Examples of magenta couplers include: couplers described in JP-A No. 3-39737 (L-57 (page 11, lower right column), L-68 (page 12, lower right column), and L-77 (page 13, lower right column)); couplers described in EP 456,257 (A-4-63 (page 134) and A-4-73 to 75 (page 139)); couplers described in EP 486,956 (M-4, -6 (page 26) and M-7 (page 27)); couplers described in JP-A No. 6-43611 (M-45 in paragraph 0024); couplers described in JP-A No. 5-204106 (M-1 in paragraph 0036); and couplers described in JP-A No. 4-362631 (M-22 in paragraph 0237).

Examples of cyan couplers include: couplers CX-1, 3, 4, 5, 11, 12, 14 and 15 (pages 14 to 16) in JP-A No. 4-204843; couplers C-7 and 10 (page 35), 34 and 35 (page 37), and (I-1) and (I-17) (pages 42 and 43) in JP-A No. 4-43345; and couplers represented by the general formula (Ia) or (Ib) described in claim 1 of JP-A No. 6-67385.

Examples of polymer couplers include couplers P-1 and P-5 (page 11) in JP-A No. 2-44345.

Couplers which provides colored dyes having proper diffusibility are preferably those described in U.S. Pat. No. 4,366,237, GB 2,125,570, EP 96,873B and DE 3,234,533.

Preferred couplers for correcting unnecessary absorption of colored dyes are yellow-colored cyan couplers (particularly, YC-86 on page 84) represented by the formulae (CI), (CII), (CIII) and (CIV) described on page 5 in EP 456,257A1; yellow-colored magenta couplers ExM-7 (page 202), Ex-1 (page 249), and EX-7 (page 251) in EP 456,257A1; magenta-colored cyan couplers CC-9 (column 8) and CC-13 (column 10) described in U.S. Pat. No. 4,833,069; and colorless masking couplers in (2) (column 8) of U.S. Pat. No. 4,837,136 and those represented by the formula (A) in claim 1 (particularly, exemplary compounds on pages 36 to 45) of WO92/11,575.

### Non-photosensitive Photographic Component Layer

The silver halide photographic photosensitive layer of the present invention may also include a non-photosensitive photographic component layer such as an undercoat layer, and the structure of the undercoat layer and method for forming the same have been already described above in detail.

The above-described silver halide photographic photosensitive layer can be formed by applying, on a substrate or on an undercoat layer provided on the substrate, the coating liquid for a silver halide photosensitive layer, which is as described above prepared as a silver halide emulsion, using a well-known coating method. In this case, formation of layers on the substrate is generally carried out in such a manner that an undercoat layer is formed on one side of the substrate, and thereafter, an antistatic layer and a protective layer are formed on another side thereof sequentially in this order, and a silver halide photographic photosensitive layer is formed on the undercoat layer.

The silver halide photographic photosensitive material of the present invention consists of the above-described supporting material of the present invention. Therefore, a haze value of the supporting material is 1.0 or less, and the surface of the silver halide photographic photosensitive layer has a conductivity so that the surface electrical resistance thereof is in a range from 8×10⁷ to 6×10⁹ Ω.

### Photosensitive Transfer Material

The photosensitive transfer material of the present invention is formed by using the above-described supporting material of the present invention, and also has at least a photosensitive resin layer on the surface thereof with none of antistatic layer and protective layer provided thereon, and if necessary, it has other layers such as a thermoplastic resin layer or an intermediate layer (oxygen blocking layer).

### Photosensitive Resin Layer

The above-described photosensitive resin layer is a colored layer containing a photosensitive resin composition and a coloring agent, preferably, a resin layer softened or fluidized due to heat or pressure. Concretely, the photosensitive resin layer is preferably one which is suitable for transfer in that it exhibits thermoplasticity such that it is softened or made sticky at least at the temperature of 150° C. or lower, and is preferably hardened by being irradiated with light, and a non-irradiated portion thereof preferably has solubility and resistivity for alkali solution. Most of the layers comprised of well-known photopolymerization composition each have the above-described properties. Further, these layers can be further modified due to addition of thermoplastic resin and compatible plasticizer.

The above-described photosensitive resin composition may be any one of those described in JP-A No. 3-282404, for example, a photosensitive resin composition comprised of negative type diazo resin and a binder; a photosensitive resin composition comprised of photopolymerization composition, an azide compound and a binder; and cinnamic acid type photosensitive resin composition.

Among them, alkali-soluble binder polymer, monomer having an ethylenic unsaturated double bond which allows addition polymerization due to irradiation of light, and a photosensitive resin composition comprising photopolymerization initiator are preferable. In the present invention, a photosensitive resin layer containing the photosensitive resin composition and a coloring agent is particularly preferable.

Examples of the above-described alkali soluble binder polymer include a polymer having a carboxylic acid group in a side chain thereof, for example, methacrylic acid copolymers, acrylic acid copolymers, itaconic acid copolymers, crotonic acid copolymers, maleic acid copolymer and partially esterified maleic acid copolymer, described in JP-A No. 59-44615, JP-B No. 54-34327, JP-B No. 58-12577, JP-B No. 54-25957, JP-A No. 59-53836 and JP-A No. 59-71048. Further, cellulose derivatives having a carboxylic acid group in a side chain thereof may also be used.

In addition, a polymer having a hydroxyl group, to which cyclic acid anhydride being added, is suitably used. Particularly, copolymers of benzyl(meth)acrylate and (meth)acrylic acid, and graft copolymer of benzyl(meth)acrylate, (meth)acrylic acid and other monomer, described in U.S. Pat. No. 4,139,391 are preferable.

When the above-described alkali soluble binder polymer is used, of the above-described polymers, those having an acid value of 50 to 300 mgKOH/g and a mass average molecular weight of 1000 to 300000 are preferably selected and used.

In addition to the above-described alkali soluble binder polymer, for the purpose of improving various properties, for example, the strength of a hardened film, alkali insoluble polymers such as alcohol soluble nylon or epoxy resin may also be added unless development performance and the like is adversely affected thereby.

The total content of the alkali soluble polymer and alkali insoluble polymer (if necessary) is preferably in a range from 10 to 95 mass % based on the total solids of the photosensitive resin composition, and more preferably in a range from 20 to 90 mass %. If the content is less than 10 mass %, the adhesiveness of the photosensitive resin layer may become too high. If the content is greater than 95 mass %, the intensity of an image to be formed and light sensitivity may be deteriorated.

As the monomer having an ethylenic unsaturated double bond which allows addition polymerization due to irradiation of light, compounds having at least one ethylenic unsaturated group allowing addition polymerization in a molecule and which has a boiling point of 100° C. or higher under a normal pressure are provided. Examples of the compounds include: monofunctional acrylate or methacrylate such as polyethyleneglycol mono(meth)acrylate, polypropyleneglycol mono (meth) acrylate, and phenoxyethyl(meth) acrylate; polyethyleneglycol di(meth)acrylate, polypropyleneglycol di(meth)acrylate, trimethylolethane triacrylate, trimethylolpropane triacrylate, trimethylolpropane diacrylate, neopentylglycol di(meth)acrylate, pentaerythritol tetra(meth)acrylate, pentaerythritol tri(meth) acrylate, dipentaerythritol hexa(meth) acrylate, dipentaerythritol penta(meth)acrylate, hexanediol di(meth)acrylate, trimethylolpropane tri(acryloyloxypropyl)ether, tri (acryloyloxyethyl)isocyanurate, tri(acryloyloxyethyl) cyanurate and glycerine tri(meth)acrylate; and polyfunctional acrylate or polyfunctional methacrylate in which polyfunctional alcohol such as trimethylolpropane or glycerine to which ethylene oxide or propylene oxide is added, is (meth)acrylated.

Further, polyfunctional acrylate or methacrylate such as urethane acrylates described in JP-B Nos. 48-41708 and 50-6034 and JP-A No. 51-37193; polyester acrylates described in JP-A No. 48-64183 and JP-B Nos. 49-43191 and 52-30490; and epoxy acryaltes which are reaction products of epoxy resin and (meth)acrylic acid, may also be provided.

Among these examples, trimethylolpropane tri(meth)acrylate, pentaerythritol tetra(meth) acrylate, dipentaerithritol hexa(meth)acrylate, and dipentaerithritol penta(meth)acrylate are preferable.

The monomers having an ethylenic unsaturated double bond which allows addition polymerization due to irradiation of light, may be used singly or may be used in a combination of two or more.

Further, the content of the monomer is generally 5 to 50 mass % based on the total solids of the photosensitive resin composition, and particularly preferably 10 to 40 mass %. If the content is less than 5 mass %, light sensitivity or image intensity may be deteriorated. If the content is greater than 50 mass %, the adhesiveness of the photosensitive resin layer may become excessively high. Neither case is preferable.

Examples of the photopolymerization initiator include: a vicinalpolyketaldonyl compound described in U.S. Pat. No. 2,367,660; an acyloin ether compound described in U.S. Pat. No. 2,448,828; an aromatic acyloin compound substituted with α-hydrocarbon described in U.S. Pat. No. 2,722,512; a polynuclear quinone compound described in U.S. Pat. Nos. 3,046,127 and 2,951,758; a combination of triarylimidazole dimer and p-aminoketone described in U.S. Pat. No. 3,549,367; a benzothiazole compound and a trihalomethyl-s-triazine compound described in JP-B No. 51-48516; a trihalomethyl-s-triazine compound described in U.S. Pat. No. 4,239,850; and a trihalomethyloxadiazole compound described in U.S. Pat. No. 4,212,976.

Among these compounds, a trihalomethyl-s-triazine, trihalomethyloxadiazole and triarylimidazole dimer are preferable.

The content of the photopolymerization initiator is generally 0.5 to 20 mass % based on the total solids of the photosensitive resin composition, and particularly preferably 1 to 15 mass %. If the content is less than 5 mass %, the light sensitivity or image intensity may be deteriorated. Further, even if the content is greater than 20 mass %, an effect for performance improvement in cannot be recognized.

As the above-described coloring agent (coloring material), pigments of red, green and blue, for form a color filter, are generally used. Preferred examples of the pigments include carmine 6B (C.I. 12490), phthalocyanine green (C.I. 74260) and phthalocyanine blue (C.I. 74160).

The above-described photosensitive resin layer can be formed by coating, on the surface of the above-described supporting material of the present invention not having the antistatic layer and protective layer provided thereon, the coating liquid containing at least the photosensitive resin composition and the coloring agent, using a well-known coating method.

### Thermoplastic Resin Layer

The above-described thermoplastic resin layer is provided for the purpose of preventing contamination of air bubbles at the time of transfer, and mainly contains alkali soluble thermoplastic resin, and if necessary, may also contain other components.

The above-described thermoplastic resin preferably has a substantial softening point of 80° C. or less. However, organic high molecular substance having a softening point of 80° C. or higher may also be used in such a manner that the substantial softening point thereof is decreased to 80° C. or less with various plasticizers compatible with the organic high polymer being added thereto.

Examples of the alkali soluble thermoplastic resin having the softening point of 80° C. or less include organic high polymers whose softening point is 80° C. or less and which is soluble in an alkali solution, which polymers are described in “Plastic Performance Handbook” edited by Nippon Plastic Industry Union and All Japan Plastic Formation Kohgyo Joint Conference, issued by Kohgyo Research on Oct. 25, 1968). Examples include saponified products of ethylene and acrylic acid ester copolymers, saponified products of styrene and (meth)acrylic acid ester copolymers, saponified products of vinyltoluene and (meth)acrylic acid ester copolymers, poly(meth)acrylic acid ester, saponified products of (meth)acrylic acid ester coplymer of butyl (meth)acrylate and vinyl acetate, and the like.

### Intermediate Layer

As the intermediate layer, an oxygen cutoff layer or the like is preferably provided for the purpose of preventing diffusion of oxygen from the air, which inhibits photo-curing reaction in the photosensitive resin layer during pattern exposure, and also preventing the photosensitive resin layer and the thermoplastic resin layer if provided, from mixing each other.

The above-described oxygen cutoff layer is mainly constituted from a resin component which can be dispersed or dissolved in water or alkali solution, and if necessary, it may also contain other components such as a surface active agent.

Examples of the resin component constituting the oxygen cutoff layer, include polyvinylether/maleic anhydride polymer, water soluble salts of carboxyalkylcellulose, water soluble cellulose ethers, water soluble salts of carboxyalkyl starch, polyvinyl alcohol, polyvinyl pyrolidone, various polyacrylamides, various water soluble polyamides, water soluble salts of polyacrylate, gelatin, ethylene oxide polymer, water soluble salts of a group consisting various starch and analogs, styrene/maleic acid copolymer, maleate resin, and a combination of two or more thereof.

Among them, a combination of polyvinyl alcohol and polyvinyl pyrolidone is particularly preferable.

A method for forming a color filter film (colored film) from the photosensitive transfer material of the present invention is carried out, for example, in a manner described below.

First, a photosensitive resin layer is made to closely contact a substrate to be transferred, under a pressurized and heated atmosphere, and is adhered together by a well-known laminator, a vacuum laminator or the like. Thereafter, the supporting material is peeled off at the boundary surface between the photosensitive resin layer and the thermoplastic resin layer, and the photosensitive resin layer is exposed in a pattern-like manner from the upper side of the thermoplastic resin layer through the thermoplastic resin layer and the oxygen cutoff layer. After the exposure, the thermoplastic resin layer, the oxygen cutoff layer, and the unnecessary portion (the non-cured portion) of the photosensitive resin layer are removed by development processing. As a result, only the illuminated portion remains on the substrate and a colored film is formed thereon. This operation is carried out repeatedly by using the photosensitive transfer materials for forming colored films of red, green and blue, thereby resulting in formation of a color filter film comprised of colors RGB.

Further, the supporting material of the present invention can also be used as a supporting material for an instant photographic film.

### Examples

Examples of the present invention will be described below, but the present invention is not limited to the same.

### Example 1

### Preparation of Silver Halide Photographic Photosensitive Material

### Preparation of Supporting Material

### Preparation of Substrate

A polyethylene terephthalate (PET) film having a thickness of 63 μm was prepared in such a manner that polyethylene terephthalate was subjected to biaxial drawing (longitudinal and transverse dimensions thereof are each drawn to 3.3 times) and thermally fixed for 10 minutes at 240° C., and thereafter, both surfaces thereof was subjected to corona discharging.

### Preparation of Supporting Material

A coating liquid for forming a first undercoat layer (coating liquid for a first undercoat layer) and a coating liquid for forming a second undercoat layer (coating liquid for a second undercoat layer), which have the following compositions, were prepared. Subsequently, the coating liquid for a first undercoat layer was applied to one surface of the above-described PET film by a bar coater and dried for 30 seconds at 140° C. and the first undercoat layer of 0.6 μm in thickness was formed, and thereafter, the coating liquid for a second undercoat layer was applied to the first undercoat layer and dried for 30 seconds at 140° C. and the second undercoat layer of 0.16 μm in thickness was formed on the first layer.

The first undercoat layer and the second undercoat layer are provided in that order on the substrate in layers.

| | |
|---|---|
| Composition of coating liquid for first undercoat layer: | |
| styrene/butadiene copolymer latex | 319.2 mg/m² |
| (ratio of copolymerization: 67/33) | |
| 2,4-dichloro-6-hydroxy-s-triazine sodium salt | 11.1 mg/m² |
| Composition of coating liquid for second undercoat layer: | |
| decalcified high molecular weight gelatin | 134.4 mg/m² |
| barium strontium sulfate (grain size: 1.5 μm) | 23.5 mg/m² |
| isothiazoline | 0.5 mg/m² |
| glycine | 3.4 mg/m² |

Subsequently, a coating liquid for an antistatic layer having the following composition was applied to the surface of the substrate having no undercoat layers provided thereon, and dried for 30 seconds at 140° C. to thereby form an antistatic layer having a thickness of 0.15 μm.

| Coating liquid for protective layer: | |
|---|---|
| acrylic ester copolymer (Jurimar ET-410: | 38 mg/m² |
| manufactured by Nippon Junyaku) | |
| dodecyldiphenylether disodium sulfonate | 4.1 mg/m² |
| (Sandet BL: manufactured by Sanyo Chemical | |
| Industries, Ltd.) | |
| tin dioxide/antimony (acicular metal oxide | 122.9 mg/m² |
| grains; FS-10D, ratio of major axis to minor | |
| axis: 20 to 30, major axis: 0.2 to 2.0 μm, | |
| minor axis: 0.01 to 0.02 μm; manufactured | |
| by Ishihara Sangyo Kaisha, Ltd.) | |
| polyoxyethylenephenyl ether | 4.1 mg/m² |
| methylated melamine based resin (Sumitex | 24.1 mg/m² |
| Resin M-3: manufactured by Sumitomo Chemical | |
| Co., Ltd.) | |

Subsequently, a coating liquid for a protective layer having the following composition was applied to the above-described antistatic layer by a bar coater and dried for 30 seconds at 140° C. to thereby form a protective layer of 0.033 μm thereon.

| Coating liquid for protective layer: | |
|---|---|
| polyolefin ionomer (Chemipal S-120: | 30.5 mg/m² |
| manufactured by Mitsui Petrochemical | |
| Industries, Ltd.) | |
| polyoxyethyleneoctylphenyl ether/glycidol | 4.1 mg/m² |
| addition product | |
| polyoxyethylenephenyl ether | 4.1 mg/m² |
| colloidal silica (Snowtex C, grain size: | 6.8 mg/m² |
| 0.020 μm: manufactured by Nissan | |
| Chemical Industries, Ltd.) | |
| polyglycerol polyglycidyl ether (epoxy | 12.0 mg/m² |
| crosslinking agent; DENACOL EX-521: | |
| manufactured by Nagase Kasei Kogyo Co., Ltd.) | |
| hexadecyloxysodium sulfonate (sulfuric | 6.2 mg/m² |
| ester based surface active agent; NIKKOL SCS: | |
| manufactured by Nikko Chemicals Co., Ltd.) | |

### Preparation of Coating Liquid for Silver Halide Photosensitive Layer

### Preparation of Base Emulsion (O-layer Emulsion (Em-O) and U-layer Emulsion (Em-U)

To 100 cc of a 3% gelatin aqueous solution kept at 58° C. and sufficiently stirred, liquid 1 (1000 cc of aqueous solution containing 1 mol of silver nitrate) and liquid 2 (mixed aqueous solution of KBr and KI) were added over 30 minutes while being adjusted and the rate of addition was such that a cube-forming silver potential was obtained, thereby preparing a cubic monodisperse emulsion of AgBrI (content of I: 1.0 mol %) having an average grain size of about 0.15 μm and a coefficient of variation of about 10%. The obtained emulsion was rinsed and demineralized by an ordinary sedimentation method, and 75 g of dispersion gelatin and an antiseptic agent (phenoxyethanol) were added thereto and heat-molten at 40° C. Thereafter, the resulting mixture was divided into two equal parts, and the two parts were each subjected after ripening, to an optimum performance at 65° C. and under a pH of 7.00, with the amount of auric acid chloride (2.5×10⁻⁶ mol) and the amount of desensitizer, that is, the following compound 1 (2×10⁻⁴ mol) being each made equal for the two parts and the amount of a fogging agent (thioureadioxide) being varied for each part. As a result, O-layer emulsion Em-O (amount of fogging agent: 2.5×10⁻⁶ mol) and U-layer emulsion Em-U (amount of fogging agent: 3.5×10⁻⁶ mol), having different sensitivities (LogE value: about 0.3) were prepared.

### Compound 1

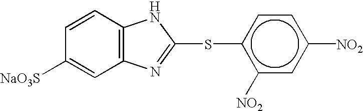

### Preparation of Coating Liquids

Coating liquids having the following formulations were prepared by using the above-described two kinds of base emulsions (Em-O and Em-U).

| Formulation of O-layer emulsion (coating liquid): | | |
|---|---|---|
| the above-described base emulsion (Em-O) | 900 | mg/m² |
| gelatin (contained in the above base emulsion) | 0.8 | g/m² |
| desensitizing dye (the following compound 4) | 11 | mg/m² |
| the following compound 5 | 5 | mg/m² |
| acetic acid | 13 | mg/m² |
| polystyrene sodium sulfonate | 36 | mg/m² |
| 1,3-divinylsulfonyl-2-propanol | 150 | mg/m² |
| Formulation of U-layer emulsion (coating liquid): | | |
| the above-described emulsion (EM-U) | 300 | mg/m² |
| gelatin (contained in the above base emulsion) | 260 | mg/m² |
| desensitizing dye (the following compound 4) | 1.8 | mg/m² |
| the following compound 5 | 5 | mg/m² |
| acetic acid | 4.4 | mg/m² |
| polystyrene sodium sulfonate | 12 | mg/m² |
| Formulation of coating liquid for | | |
| antihalation undercoat layer (AHU): | | |
| gelatin | 1.8 | g/m² |
| Proxel | 3.1 | mg/m² |
| solid disperse dye (the following compound 6) | 17.3 | mg/m² |
| solid disperse dye (the following compound 7) | 83.7 | mg/m² |
| phosphoric acid | 44 | mg/m² |
| dodecylbenzene sodium sulfonate | 16 | mg/m² |
| polystyrene sodium sulfonate | 18 | mg/m² |
| 1,3-divinylsulfonyl-2-propanol | 79 | mg/m² |
| Formulation of coating liquid | | |
| for emulsion protective layer: | | |
| gelatin | 800 | mg/m² |
| Proxel | 1.5 | mg/m² |
| strontium barium sulfate | 27 | mg/m² |
| (average grain size: 1.5 μm) | | |
| liquid paraffin emulsified product | 59 | mg/m² |
| dodecylbenzene sodium sulfonate | 19 | mg/m² |
| fluorine based surface active agent | 4 | mg/m² |
| (the following compound 2) | | |
| surface active agent (the following compound 3) | 15 | mg/m² |
| colloidal silica (average grain size: 0.2 μm) | 69 | mg/m² |
| EDTA | 14 | mg/m² |
| acetic acid | 4 | mg/m² |
| polystyrene sodium sulfonate | 6 | mg/m² |
| hydroquinon | 6 | mg/m² |
| potassium bromide | 97 | mg/m² |

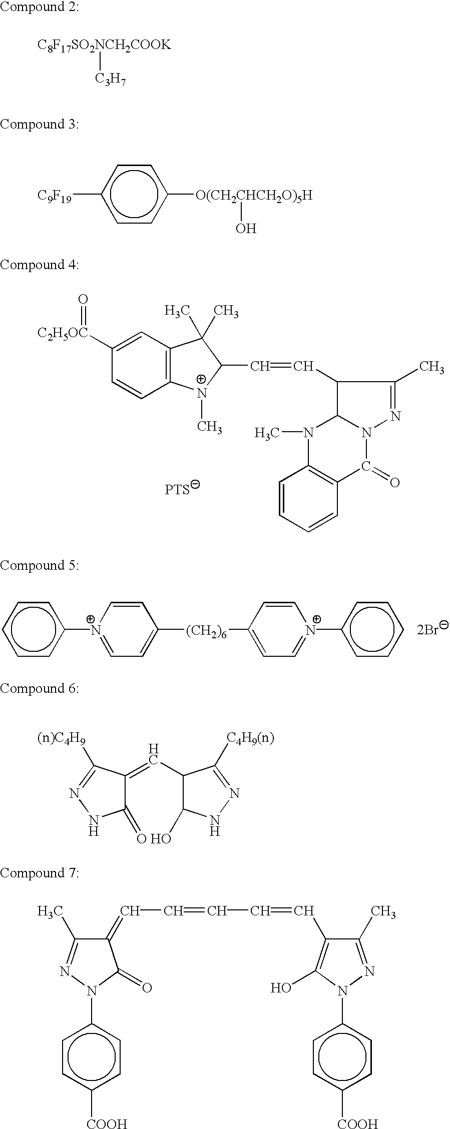

### Preparation of Silver Halide Photographic Photosensitive Material

On the second undercoat layer of the PET film having the first and second undercoat layers formed in layers, the coating liquid for an antihalation undercoat layer (AHU), the U-layer emulsion (coating liquid), the O-layer emulsion (coating liquid) and the coating liquid for an emulsion protective layer were applied in layers sequentially in this order.

As a result, the silver halide photographic photosensitive layer (1) of the present invention was obtained, wherein the first undercoat layer, second undercoat layer, antihalation undercoat layer, U layer (silver halide photographic photosensitive layer), O layer (silver halide photographic photosensitive layer), and emulsion protective layer are formed in layers on one side of the PET film, and the antistatic layer and protective layer are formed in layers on another side thereof. The swelling rate on the side of the film with the silver halide photographic photosensitive layers provided thereon was 110% and the pH of the film surface was 5.6.

### Example 2

A silver halide photographic photosensitive material (2) of the present invention was obtained as in Example 1 except that the drying temperature (the maximum temperature) when the antistatic layer and the protective layer are formed, was changed to 120° C. or to 160° C. (see Table 1 shown below).

### Comparative Examples 1 to 7

Silver halide photographic photosensitive materials (3) to (9) of comparative examples were each obtained as in Example 1 except that the antistatic agent contained in the coating liquid for an antistatic layer prepared by Example 1, and the epoxy cross-linking agent and sulfuric ester based surface active agent which are contained in the coating liquid for a protective layer prepared by Example 1 were each changed as indicated in Table 1 shown below.

TABLE 1

| | | | Sulfuric | |
|---|---|---|---|---|
| | | Protective | ester | Maximum |
| | | layer | based sur- | drying |
| | Antistatic layer | Epoxy cross- | face active | temperature |
| | Antistatic agent | linking agent | agent (*9) | (° C.) |
| Example 1 | Acicular grains | EX-521 (*6) | contained | 140 |
| | (*1) | | | |
| Example 2 | Acicular grains | EX-521 (*6) | contained | 160 |
| | (*1) | | | |
| Comparative | Spherical grains | EX-521 (*6) | contained | 140 |
| Example 1 | (*2) | | | |
| Comparative | Spherical grains | EX-521 (*6) | contained | 140 |
| Example 2 | (*3) | | | |
| Comparative | Spherical grains | EX-521 (*6) | contained | 140 |
| Example 3 | (*4) | | | |
| Comparative | Spherical grains | EX-521 (*6) | contained | 140 |
| Example 4 | (*5) | | | |
| Comparative | Acicular grains | EX-614 (*7) | contained | 140 |
| Example 5 | (*1) | | | |
| Comparative | Acicular grains | EX-810 (*8) | contained | 140 |
| Example 6 | (*1) | | | |
| Comparative | Acicular grains | EX-521 (*6) | none | 140 |
| Example 7 | (*1) | | | |

*1: FS-10D (tin dioxide/antimony), manufactured by Ishihara Sangyo Kaisha, Ltd.
*2: SN-38F (tin dioxide/antimony), grain size: 0.055 μm, manufactured by Ishihara Sangyo Kaisha, Ltd.
*3: SN-100F (tin dioxide/antimony), grain size: 0.100 μm, manufactured by Ishihara Sangyo Kaisha, Ltd.
*4: TDL-S (tin dioxide/antimony), grain size: 0.070 μm, manufactured by Mitsubishi Materials Corp.
*5: TDL-1 (tin dioxide/antimony), grain size: 0.125 μm, manufactured by Mitsubishi Materials Corp.
*6: polyglycerolpolyglycidyl ether (the number of average epoxy functional group: 6.3), manufactured by Nagase Kasei Kogyo Co., Ltd.
*7: solbitolpolyclycidyl ether, manufactured by Nagase Kasei Kogyo Co., Ltd.
*8: ethylene glycol glycidyl ether, manufactured by Nagase Kasei Kogyo Co., Ltd.
*9: hexadecyloxy sodium sulfonate: NIKKOL SCS, manufactured by Nikko Chemicals Co., Ltd.

### Evaluation

The silver halide photographic photosensitive materials (1) and (2) of the present invention, and the silver halide photographic photosensitive materials (3) to (9) of the comparative examples were evaluated as follows. The results of evaluation are shown in Table 2.

(1) Surface Electrical Resistance (SR)

The surface electrical resistance was measured for each of the silver halide photographic photosensitive materials (1) to (9) based on a method described in the section on resistivity of JIS-K-6911-1979 before and after development processing of each silver halide photographic photosensitive material. The photosensitive materials were each left for 6 hours at 23° C. and in an atmosphere of 65% RH to allow conditioning of the humidity thereof. Thereafter, the measurement was carried out in the same atmosphere by using a constant voltage power source (TR-300C, manufactured by Takeda Riken Co.), an ammeter (TR-8651, manufactured by Takeda Riken Co.) and a sample chamber (TR-42, manufactured by Takeda Riken Co.).

(2) Haze

The haze in each of the photosensitive materials in a state before a silver halide photographic photosensitive layer is formed (that is, a state in which the first and second undercoat layers are formed on one side of the PET film, and the antistatic layer and protective layer are formed on another side thereof), was measured based on a method described in the section on cloud value of JIS-K-6714-1977, and shown as an index for indicating transparency. The measurement was carried out by using a haze meter (NDH-1001P, manufactured by Nihon Denshoku Kohgyo K.K.). As the numerical value becomes greater, a more excellent transparency is obtained.

(3) Falling-off of Grains and Adhesion of Foreign Matters Caused by Conveying

In each of the photosensitive materials, a film in a state before the silver halide photographic photosensitive layer is formed thereon (that is, in a state in which the first and second undercoat layers are formed on one side of the PET film, and the antistatic layer and protective layer are formed on another side thereof), was processed into an elongated film having a transverse dimension of 18 cm, and was kept for three days at 25° C. and in an atmosphere of 65% RH. Thereafter, the elongated film was conveyed for 5 minutes at a line speed of 100 m/minute using a handling tester which simulates an emulsion coater in a state in which a drive roll (flat roll) of the tester, which has a lap angle of 180 degrees, is reversed so that the peripheral speed thereof becomes 90 m/minute. The amount of powder-like product adhering to the surface of the drive roll was evaluated visually based on the following criterion.

### Criterion

AA: Adhesion of no foreign matters was recognized.

BB: Adhesion of a very small amount of foreign matters was recognized.

CC: Adhesion of a small amount of foreign matters was recognized.

DD: Adhesion of a considerable amount of foreign matters was recognized.

(4) Scratch Resistance

The scratch resistance was measured for each of the photosensitive materials (each containing the silver halide photographic photosensitive layer) kept for three days at 25° C. and in an atmosphere of 65% RH, by using a scratch hardness tester (HEIDON-18, manufactured by SHINTO-KAGAKU CO., LTD.) under the condition that the load of a pressing 0.025R diamond needle is continuously increased from 0 to 100 g. The load at which defects begins to be formed, is represented by a gram unit. As the numerical value becomes greater, a more excellent scratch resistance is obtained.

(5) Lubricating Property

The coefficient of dynamic friction was measured for each of the photosensitive materials (each containing the silver halide photographic photosensitive layer) kept for three days at 25° C. and in an atmosphere of 65% RH, by using a machine for measuring a coefficient of dynamic friction (manufactured by TOYO BALDWIN CO., LTD.). That is, a steel ball of 5 mm in diameter, to which a load of 20 g is applied, was made to contact with the surface of a sample film, and a resistance when the steel ball was glided on the film at the speed of 20 cm/minute, was obtained by being detected with a strain gauge. As the numerical value becomes greater, the lubricating property becomes inferior.

TABLE 2

| | | | Surface electrical | | | |
|---|---|---|---|---|---|---|
| | | | resistance (× 10⁹) | | | |
| | Adhesion | Scratch | Before | After | Haze | |
| | of foreign | resistance | develop- | develop- | value | Lubricating |
| | matters | (g) | ment (Ω) | ment (Ω) | (%) | property |
| Example 1 | AA | 98 | 1.4 | 2.5 | 0.81 | 0.121 |
| Example 2 | BB | 97 | 1.3 | 2.3 | 0.82 | 0.115 |
| Comparative | BB | 95 | 6.3 | 7.8 | 0.65 | 0.115 |
| Example 1 | | | | | | |
| Comparative | CC | 85 | 6.7 | 8.1 | 1.55 | 0.282 |
| Example 2 | | | | | | |
| Comparative | BB | 92 | 6.5 | 7.9 | 0.70 | 0.120 |
| Example 3 | | | | | | |
| Comparative | CC | 83 | 6.8 | 8.3 | 1.65 | 0.300 |
| Example 4 | | | | | | |
| Comparative | BB | 89 | 1.5 | 2.5 | 0.83 | 0.121 |
| Example 5 | | | | | | |
| Comparative | DD | 86 | 1.7 | 2.6 | 0.78 | 0.125 |
| Example 6 | | | | | | |
| Comparative | BB | 73 | 1.2 | 2.0 | 0.75 | 0.385 |
| Example 7 | | | | | | |

As can be seen from Table 2, the silver halide photographic photosensitive materials (1) and (2) in which the antistatic layer contains acicular metal oxide grains, and the protective layer contains an epoxy cross-linking agent and a sulfuric ester based surface active agent, have a low surface electrical resistance and excellent antistatic properties, and adhesion of foreign matters caused by dropping-off of grains or peeling-off of a layer was hardly found. Moreover, the photosensitive materials having excellent lubricating properties and scratch resistance, and also having a high transparency can be obtained. Still further, in the silver halide photographic photosensitive material (1) in which respective drying temperatures (maximum temperatures) after application of the coating liquid for an antistatic layer and the coating liquid for a protective layer, were each set at 140° C., the film membrane strength and electrical conductivity (a low surface electrical resistance) are particularly excellent, and white-powder contamination or adhesion of foreign matters, caused by falling-off of grains, can be effectively prevented.

On the other hand, in the silver halide photographic photosensitive materials (3) to (6) in which no acicular metal oxide grain was used in the antistatic layer, the surface electrical resistance is not reduced, and white-powder contamination or adhesion of foreign matters, caused by falling-off of grains, is not prevented. In the silver halide photographic photosensitive material (9) in which no sulfuric ester based surface active agent is used in the protective layer, sufficient lubricating property is not obtained and scratch resistance is also deteriorated. Further, in a case in which the average number of epoxy functional groups is outside the range provided by the present invention, the film membrane strength is deteriorated.

According to the present invention, a supporting material can be provided which has excellent electric conductivity and antistatic ability and has a high film membrane strength, and in which peeling-off of a layer in a manufacturing process or at the time of handling (coating or conveying) is prevented. White-powder contamination and adhesion of foreign matters caused by dropping-off of an antistatic agent and also failure of liquid film repellency caused by the white-powder powder contamination and adhesion of foreign matters is prevented. This supporting material also gas excellent transparency and scratch resistance. Further, silver halide photographic photosensitive material and photosensitive transfer material can also be provided which each have excellent electric conductivity and antistatic ability and which can prevent deterioration of the antistatic ability caused by peeling-off of a film at the time of handling (conveying or development) or falling-off of an antistatic agent, or degradation of a developing solution, and which can reduce operational burden of an automatic processor, and which also has excellent transparency and scratch resistance, thereby making it possible to form a high-quality image free from any image defect.

What is claimed is:

1. A supporting material having an antistatic layer formed on one surface of a substrate and a protective layer formed on the antistatic layer,
wherein the antistatic layer comprises acicular metal oxide grains.

2. A supporting material having an antistatic layer formed on one surface of a substrate and a protective layer formed on the antistatic layer,
wherein the protective layer comprises an epoxy cross-linking agent, and a sulfuric ester based surface active agent represented by CₙH₂ₙ₊₁OSO₃Na, wherein n represents an integer of 12 to 18.

3. A supporting material according to claim 1, wherein the protective layer comprises an epoxy cross-linking agent, and a sulfuric ester based surface active agent represented by CₙH₂ₙ₊₁OSO₃Na, wherein n represents an integer of 12 to 18.

4. A supporting material according to claim 2, wherein the epoxy cross-linking agent is an epoxy cross-linking agent in which the average number of epoxy functional groups in a molecule is 4.5 to 6.5.

5. A supporting material according to claim 3, wherein the epoxy cross-linking agent is an epoxy cross-linking agent in which the average number of epoxy functional groups in a molecule is 4.5 to 6.5.

6. A supporting material according to claim 1, wherein the ratio of a major axis of the metal oxide grains with respect to a minor axis, that is, the ratio of major axis/minor axis is 3 to 50.

7. A supporting material according to claim 3, wherein the ratio of a major axis of the metal oxide grains with respect to a minor axis, that is, the ratio of major axis/minor axis is 3 to 50.

8. A supporting material according to claim 6, wherein the metal oxide grains are selected from a group consisting of SnO₂, ZnO, Al₂O₃, TiO₂, In₂O₃ and MgO.

9. A supporting material according to claim 7, wherein the metal oxide grains are selected from a group consisting of SnO₂, ZnO, Al₂O₃, TiO₂, In₂O₃ and MgO.

10. A supporting material according to claim 3, wherein a haze value of the supporting material is 1.0 or less.

11. A supporting material according to claim 5, wherein a haze value of the supporting material is 1.0 or less.

12. A supporting material according to claim 7, wherein a haze value of the supporting material is 1.0 or less.

13. A supporting material according to claim 3, wherein at least one of the antistatic layer and the protective layer is formed by applying a liquid film on the substrate and drying the film at the temperature in a range from 120 to 140° C.

14. A silver halide photographic photosensitive material having a silver halide photographic photosensitive layer on a surface of a supporting material opposite to a side at which an antistatic layer and a protective layer are formed,
wherein the supporting material is a supporting material according to claim 1, and a surface electrical resistance value on the surface of the silver halide photographic photosensitive layer is in a range from 8×10⁷ to 6×10⁹ Ω.

15. A silver halide photographic photosensitive material having a silver halide photographic photosensitive layer on a surface of a supporting material opposite to a side at which an antistatic layer and a protective layer are formed,
wherein the supporting material is a supporting material according to claim 3, and a surface electrical resistance value on the surface of the silver halide photographic photosensitive layer is in a range from 8×10⁷ to 6×10⁹ Ω.

16. A silver halide photographic photosensitive material having a silver halide photographic photosensitive layer on a surface of a supporting material opposite to a side at which an antistatic layer and a protective layer are formed,
wherein the supporting material is a supporting material according to claim 5, and a surface electrical resistance on the surface of the silver halide photographic photosensitive layer is in a range from 8×10⁷ to 6×10⁹ Ω.

17. A silver halide photographic photosensitive material having a silver halide photographic photosensitive layer on a surface of a supporting material opposite to a side at which an antistatic layer and a protective layer are formed,
wherein the supporting material is a supporting material according to claim 7; and a surface electrical resistance on the surface of the silver halide photographic photosensitive layer is in a range from 8×10⁷ to 6×10⁹ Ω.

18. A photosensitive transfer material having a photosensitive resin layer on a surface of a supporting material opposite to a side at which an antistatic layer and a protective layer are formed,
wherein the supporting material is a supporting material according to claim 1.

19. A photosensitive transfer material having a photosensitive resin layer on a surface of a supporting material opposite to a side at which an antistatic layer and a protective layer are formed,
wherein the supporting material is a supporting material according to claim 3.

20. A photosensitive transfer material having a photosensitive resin layer on a surface of a supporting material opposite to a side at which an antistatic layer and a protective layer are formed,
wherein the supporting material is a supporting material according to claim 5.
